(19) United States
(12) Patent Application Publication
(10) Pub. No.: US 2008/0115198 A1
(43) Pub. Date: May 15, 2008

(54) Multi-factor authentication transfer

(76) Inventors: Paul J. Hsu, Fremont, CA (US); JWM Spies, San Mateo, CA (US); John Flora, Pleasanton, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/591,224

(22) Filed: Oct. 31, 2006

(51) Int. Cl. H04L 9/32; G06K 9/00; H04L 9/00; G06F 17/30; G06F 15/16; H04K 1/00; G06F 7/04; G06F 7/58; G06K 19/00

(52) U.S. Cl. 726/5; 726/6; 726/7; 713/182; 726/9

(57) ABSTRACT

A system that uses multi-factor authentication while retrieving information is described. During operation, the system requests and receives multiple authentication factors from a user of an application on a first host. These multiple authentication factors are associated with a document on a second host, and include authentication information that enables access to the document. Furthermore, the system uses the multiple authentication factors to access the document. While accessing the document, the system retrieves information from the document by navigating through the document, identifying the information, and aggregating the information.

### BACKGROUND

The present invention relates to techniques for collecting and providing authentication information.

Authentication and authorization are widely used procedures that, respectively, enable a user to access an application or system (by confirming the user's identity) and to verify the authority of the user to perform certain operations or tasks. For example, the user may provide information, such as a username, a password, or a pin number during these procedures to confirm the users' identify (authorization) and/or the user's right to transfer funds from a bank account (authorization). Note that authentication is a broader term than authorization, and authentication typically precedes or is coincident with authorization. In the discussion that follows authentication has a broad definition and, in some embodiments, includes authorization.

As security threats continue to grow, many applications and systems are significantly increasing such protection requirements. This is especially true in networked environments, such as the Internet or World Wide Web (WWW). As a consequence, many applications and systems utilize multiple authentication factors to perform authentication (also referred to as multi-factor authentication). Such multi-factor authentication may include something the user knows (for example, a password), something the user has (for example, a token), and/or something the user is (for example, a biometric feature).

Unfortunately, different applications, websites and web pages utilize a wide variety of authentication formats and factors. In addition, these formats and/or factors may be dynamic, which means they may vary over time. This complexity is often a burden to users. Furthermore, the disparate and divergent requirements also make it more difficult for the users to routinely interact, either directly or indirectly, with information portals for these applications and systems.

For example, consider financial software, which has become widely used by millions of people. This type of software offers a broad range of functionality to users, such as the ability to analyze the financial consequences of plans, to determine account balances, and to prepare annual income tax return forms. In the process, these programs often assemble and utilize considerable financial information about their users. However, existing financial software is not configured to perform multi-factor authentication in different environments. As a consequence, it is difficult for such financial software to assemble and share financial information, which makes it harder to use the financial software.

### SUMMARY

One embodiment of the present invention provides a computer system that uses multi-factor authentication while retrieving information. During operation, the system requests and receives multiple authentication factors from a user of an application on a first host. These authentication factors are associated with a document on a second host, and include authentication information that enables access to the document. Next, the system uses the multiple authentication factors to access the document. While accessing the document, the system retrieves the information from the document by navigating through the document, identifying the information, and aggregating the information.

In some embodiments, the system further provides the information to the user.

In some embodiments, the system further stores the information and/or the multiple authentication factors on the first host. Note that the information may include financial information for the user, information associated with multiple email accounts for the user, and/or medical information for the user. Furthermore, the multiple authentication factors may include a dynamic factor, such as a Rivest-Shamir-Adleman (RSA) token, that is updated after a time interval.

In some embodiments, the system repeats the accessing and retrieving operations after another time interval. For example, the accessing and retrieving operations may be repeated periodically and/or when the information is changed.

In some embodiments, the first host is a client computer and the second host is a server computer. Furthermore, in some embodiments the document includes a website or a web page.

In some embodiments, the application includes a financial application, such as Quicken™ or TurboTax™.

In some embodiments, the system aggregates the information by scraping the information from the document.

Another embodiment provides a method including at least some of the above-described operations.

Another embodiment provides a computer program product for use in conjunction with the computer system.

### BRIEF DESCRIPTION OF THE FIGURES

FIG. 1 is a block diagram illustrating a computer system that includes computers and servers that are networked together in accordance with an embodiment of the present invention.

FIG. 2 is a block diagram illustrating a computer system in accordance with an embodiment of the present invention.

FIG. 3 is a flow chart illustrating a process for retrieving information in accordance with an embodiment of the present invention.

FIG. 4 is a flow chart illustrating a process for retrieving information in accordance with an embodiment of the present invention.

FIG. 5 is a block diagram illustrating a data structure in accordance with an embodiment of the present invention.

FIG. 6 is a block diagram illustrating a data structure in accordance with an embodiment of the present invention.

Note that like reference numerals refer to corresponding parts throughout the drawings.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of a computer system, a method, and a computer program product (i.e., software) for use with the computer system are described. These devices and processes may be used to retrieve information, such as financial information for a user (for example, banking information), information associated with multiple email accounts for the user, and/or medical information for the user. In particular, an application executing on an electronic device may request and receive multi-factor authentication information one or more times from the user. For example, the application may include a financial application, such as Quicken™, TurboTax™, or other software capable of receiving financial-related data, bank statements, and/or investment records. Furthermore, the authentication information may include dynamic information (such as one or more Rivest-Shamir-Adleman or RSA tokens) that the user updates after a time interval and/or static information (such as a social security number, one or more usernames, one or more passwords, one or more pins, one or more telephone numbers, one or more addresses, and/or additional personal information).

The application may utilize such multi-factor authentication information to access a document (such as a website or web page) that is resident on a server computer. Note that communication with the server computer may be via a network, such as an Intranet and/or the Internet. Also note that accessing the document may involve authentication and/or authorization on behalf of the user.

In addition, the application may retrieve the information from the document by navigating through the document, identifying the information, and aggregating the information. The identifying and aggregating operations may be repeated after a time interval, for example, either periodically (such as daily) and/or when the information is changed. In some embodiments, the system aggregates the information by scraping the information from the document. In this technique, a program (sometimes referred to as a scraper) extracts or parses data from the document, for example, using Hypertext Markup Language (HTML) scraping.

This approach may be implemented as a stand-alone software application, or as a program module or subroutine in another application, such as the financial software. Furthermore, the software may be configured to execute on a client computer, such as a personal computer, a laptop computer, cell phone, PDA, or other device capable of manipulating computer readable data, or between two or more computing systems over a network (such as the Internet, World Wide Web or WWW, Intranet, LAN, WAN, MAN, or combination of networks, or other technology enabling communication between computing systems). Therefore, the information and/or multi-factor authentication information may be stored locally (for example, on a local computer) and/or remotely (for example, on a computer or server that is accessed via a network).

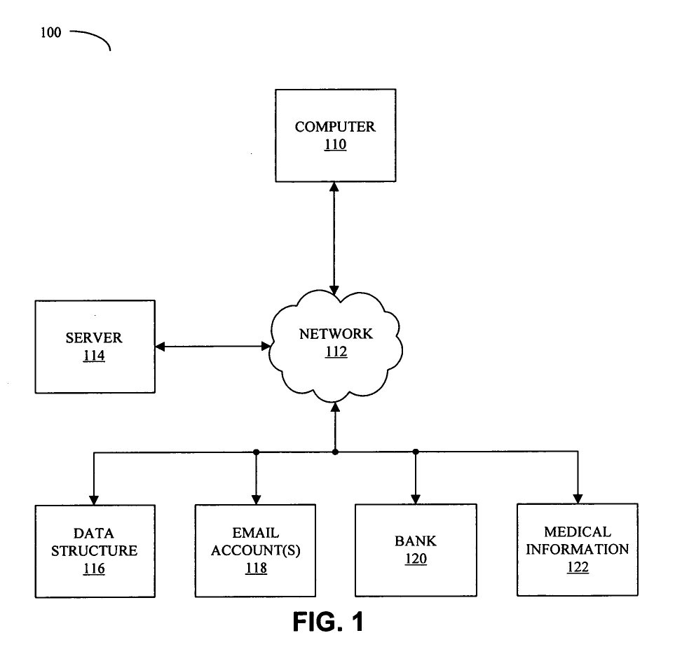

We now describe embodiments of a computer system, a method, and software for retrieving information. FIG. 1 provides a block diagram illustrating a computer system 100 that includes a number of computers and servers that are networked together in accordance with an embodiment of the present invention. One or more users may provide multi-factor authentication information to a program, such as a financial program, that executes on computer 110. As noted above, this financial program may be a stand-alone application or may be embedded in another application. In one embodiment, the financial program includes software such as Quicken™ and/or TurboTax™ (from Intuit, Inc., of Mountain View, Calif.), Microsoft Money™ (from Microsoft Corporation, of Redmont, Wash.), SplashMoney™ (from SplashData, Inc., Los Gatos, Calif.), Mvelopes™ (from In2M, Inc., Draper, Utah), and/or open-source applications such as Gnucash™, PLCash™, and/or Budget™ (from Snowmint Creative Solutions, LLC).

The financial program may be resident on the computer 110. However, other embodiments may utilize a financial tool that is embedded in a web page (once again, either as a stand-alone application or as a portion of another application). This web page may be provided by server 114 via network 112. In an illustrative embodiment, the financial tool is a software package written in JavaScript™ (i.e., the fiancial tool includes programs or procedures containing JavaScript instructions), ECMAScript (the specification for which is published by the European Computer Manufacturers Association International), VBScript™ (a trademark of Microsoft, Inc.) or any other client-side scripting language. In other words, the embedded financial tool may include programs or procedures containing JavaScript, ECMAScript instructions, VBScript instructions, or instructions in another programming language suitable for rendering by a browser or another client application on the computer 110.

The multi-factor authentication information provided by the user may include static information and/or dynamic information. For example, static information for the user may include a social security number, one or more usernames, one or more passwords, one or more pins, one or more telephone numbers, one or more addresses, and/or additional personal information. Such static information may be stored locally (i.e., on the computer 110) and/or remotely (for example, on the server 114). In addition, the dynamic information may include one or more Rivest-Shamir-Adleman (RSA) tokens. Such dynamic information may also be stored locally and/or remotely.

Note that the financial program may request updates or revisions from the user to at least some of the multi-factor authentication information as needed. For example, the financial program may request an updated or new RSA token from the user when a previous token has expired. This may be after a time interval, periodically, each time the user uses the financial program, and/or daily. Alternatively, the financial program may request an update or revision to the multi-factor authentication information when the requirements and/or format for a document (such as a website or web page) are changed.

Using the multi-factor authentication information, the financial program may access one or more documents (such as one or more websites or web pages on one or more hosts) and may retrieve stored information (such as financial information) for the user. The information to be retrieved may be initially stored locally on the computer 110 or remotely, for example, on the server 114, in a data structure 116, and/or in the financial records of a financial provider, such as a bank 120 or a brokerage (not shown). For example, the information may include bank records stored at the bank 120 (or in the financial records that are maintained by the bank 120), or the information may include investment records stored at the brokerage (or in the financial records that are maintained by the brokerage). In some embodiments, the information may include at least a portion of one or more messages in one or more email accounts 118 and/or medical information 122 (such as that stored and/or maintained by a medical provider or insurer).

The retrieval of the information may occur in real-time, i.e., while the user is using the financial program, or off-line, i.e., between user sessions. In an illustrative embodiment, the financial program may repeatedly retrieve the information, for example, on a daily basis, after a time interval, and/or when the information has changed. For example, the financial program may retrieve bank transactions on a daily basis from the bank 120.

During the retrieval of the information, the financial program may perform a set of operations. In particular, the financial program or a related application that executes on the server 114 may navigate through a given document, identify the information, and aggregate the information. For example, navigating through the document may be based on HTML or Extensible Markup Language (XML) markers in the document, and aggregating the information may include scraping the information from the document. In addition, in some embodiments aggregating the information involves assembling information that is retrieved from multiple documents on one or more hosts. Note that the retrieval of the information may be automated. However, in some embodiments the retrieval may involve at least some operator assistance (for example, by the user and/or a provider of the financial program), as needed, such as in the event of an error during the navigation through the document.

At least a portion of the information may be presented to the user during a current or future session, i.e., when the user is using the financial program. In some embodiments, the financial program performs analysis and/or calculations that utilize the retrieved information, the results of which are presented to the user. For example, if the retrieved information includes bank transactions, the financial program may calculate and present a current account balance to the user. Furthermore, the retrieved information may be stored locally and/or remotely for current or future use.

In an illustrative embodiment, the financial program (such as Quicken™) requests information from the bank 120 (such as Bank of America). The request and the retrieval are implemented, in part, by an application (henceforth referred to as Customer Central) that executes on the server 114. The request and response include the following commands in which Customer Central requests authentication information based on the requirements of the bank 120:

<?xml version=“1.0” encoding=“UTF-8”?>
<cc:CCWSResponse xmlns:cc=“http://www.intuit.com/CustomerCentral”>
<status>
<code>ok</code>
<string>call successful</string>
</status>
<body>
<ccresp:CCDiscoverAccountsInteractiveResponse
xmlns:ccresp=“http://www.intuit.com/CustomerCentral/Responses”>
<session>
<cccaptureIpAddress>172.23.29.76</cccaptureIpAddress>
<cccapturePort>9909</cccapturePort>
<ccscrapeIpAddress>172.23.29.76</ccscrapeIpAddress>
<ccscrapePort>9979</ccscrapePort>
<ccscriptInstanceId>-208666287</ccscriptInstanceId>
</session>
<questions>
<question>
<text>In what city were you born? (Enter full name of city only)</text>
</question>
</questions>
</ccresp:CCDiscoverAccountsInteractiveResponse>
</body>
</cc:CCWSResponse>.

The financial program may either request the authentication information (city of birth) from the user or may retrieve the answer (Palo Alto) from storage. Then the financial program may respond using the following command

```
<?xml version=“1.0” encoding=“utf-8” ?> <cc:CCWSRequest
  xmlns:cc=“http://www.intuit.com/CustomerCentral”>
  <authentication><tp_{—}
  partner_id>3</tp_partner_id><userId>
  ezQwQTgzNkIxLTdGRkItNDJBM
  C05RDc5LUJBOTc3MTcyMEY0NX0=</userId><password>X</
  password></authentication><body><ccreq:
  CCDiscoverAccountsInteractiveRequestxmlns:ccreq=“http://
  www.intuit.com/CustomerCentral/Requests”><session>
  <cccaptureIpAddress>172.23.29.76</cccaptureIpAddress>
  <cccapturePort>9909</cccapturePort><ccscrapeIpAddress>
  172.23.29.76
  </ccscrapeIpAddress><ccscrapePort>9979</ccscrapePort>
  <ccscriptInstanceId>208666287<ccscriptInstanceId></session><answers
>
  <answer>PaloAlto</answer></answers>
  </ccreq:CCDiscoverAccountsInteractiveRequest></body>
  </cc:CCWSRequest>AccountsInteractiveRequest></body>
  </cc:CCWSRequest>.
```

In another illustrative example, the bank 120 (such as ING bank) requires authentication information. In this example, the financial program may either request this authentication information from the user or may retrieve the answer from storage. Then, the financial program responds.

Thus, the command sequence includes:

```
<?xml version=“1.0” encoding=“UTF-8”?>
<cc:CCWSResponse xmlns:cc=“http://www.intuit.com/CustomerCentral”>
<status>
<code>ok</code>
<string>call successful</string>
</status>
<body>
<ccresp:CCRefreshAccountsInteractiveResponse
  xmlns:ccresp=“http://www.intuit.com/CustomerCentral/Responses”>
<session>
<cccaptureIpAddress>172.23.27.146</cccaptureIpAddress>
<cccapturePort>9909</cccapturePort>
<ccscrapeIpAddress>172.23.27.146</ccscrapeIpAddress>
<ccscrapePort>9979</ccscrapePort>
<ccscriptInstanceId>1717684170<ccscriptInstanceId>
</session>
<questions>
<question>
<text>In what year was your friend born?</text>
</question>
</questions>
</ccresp:CCRefreshAccountsInteractiveResponse>
</body>
</cc:CCWSResponse>
<!-- ***** SEND to https://ccpi.intuit.com/CustomerCentral/api at
14:49:04 on 20060808 ***** -->
<!-- -->
<?xml version=“1.0” encoding=“utf-8” ?> <cc:CCWSRequest
  xmlns:cc=“http://www.intuit.com/CustomerCentral”><authentication>
  <tp_partner_id>3</tp_partner_id><userId>
  e0RGMj1FOEZBLTczRjktNDFGQS05OTI0LTZEOTg3RTVF-
  QzRFRn0=
  </userId><password>X</password></authentication><body>
  <ccreq:CCRefreshAccountsInteractiveRequest
  xmlns:ccreq=“http://www.intuit.com/CustomerCentral/Requests”>
  <session><cccaptureIpAddress>172.23.27.146</cccaptureIpAddress>
  <cccapturePort>9909</cccapturePort><ccscrapeIpAddress>
  172.23.27.146</ccscrapeIpAddress><ccscrapePort>9979</
  ccscrapePort><
  ccscriptInstanceId>1717684170</ccscriptInstanceId></session>
  <answers><answer>1978</answer></answers>
  </ccreq:CCRefreshAccountsInteractiveRequest></body>
  </cc:CCWSRequest>AccountsInteractiveRequest></body>
  </cc:CCWSRequest>
<!-- ***** RECV from https://ccpi.intuit.com/CustomerCentral/api at
14:49:05 on 20060808 ***** -->
```

This approach to multi-factor authentication allows the financial program to assemble (i.e., retrieve) information for the user in a semi-automated or fully automated fashion from one or more locations. Therefore, this technique may reduce the burden associated with the security requirements for different documents, hosts, and/or systems.

The multi-factor authentication information and/or the retrieved information may be a sensitive nature. As a consequence, in some embodiments stored authentication information and/or stored retrieved information are encrypted. In addition, such information may be encrypted when it is communicated over the network 112. Note that in some embodiments the computer system 100 includes fewer or additional components, two or more components are combined into a single component, and/or a position of one or more components may be changed.

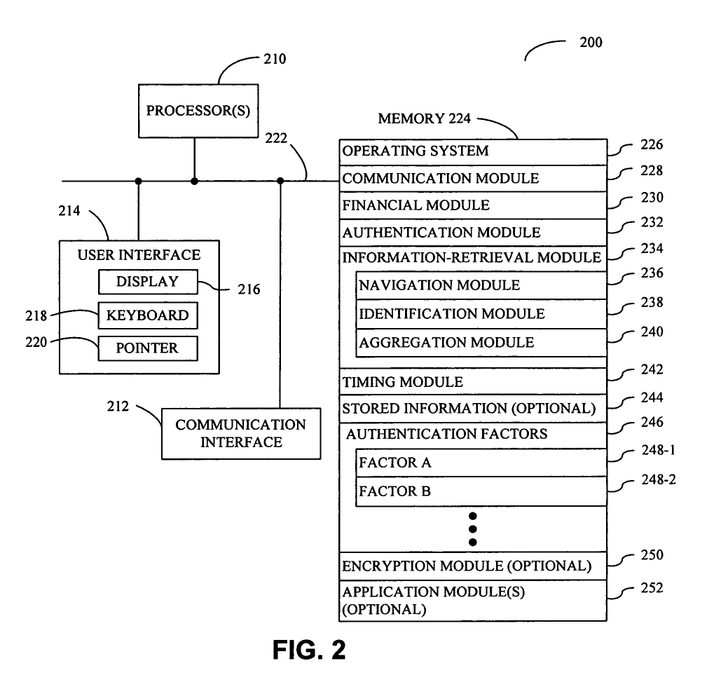

FIG. 2 provides a block diagram illustrating a computer system 200 in accordance with an embodiment of the present invention. The computer system 200 includes one or more processors 210, a communication interface 212, a user interface 214, and one or more signal lines 222 coupling these components together. Note that the one or more processing units 210 may support parallel processing and/or multi-threaded operation, the communication interface 212 may have a persistent communication connection, and the one or more signal lines 222 may constitute a communication bus. Moreover, the user interface 214 may include a display 216, a keyboard 218, and/or a pointer 220, such as a mouse.

Memory 224 in the computer system 200 may include volatile memory and/or non-volatile memory. More specifically, memory 224 may include ROM, RAM, EPROM, EEPROM, FLASH, one or more smart cards, one or more magnetic disc storage devices, and/or one or more optical storage devices. Memory 224 may store an operating system 226 that includes procedures (or a set of instructions) for handling various basic system services for performing hardware dependent tasks. While not explicitly indicated in the computer system 200, in some embodiments the operating system 226 includes a web browser. The memory 224 may also store procedures (or a set of instructions) in a communication module 228. The communication procedures may be used for communicating with one or more computers and/or servers, including computers and/or servers that are remotely located with respect to the computer system 200.

Memory 224 may also include multiple program modules (or a set of instructions), including financial module 230 (or a set of instructions) and authentication module 232 (or a set of instructions). Furthermore, memory 224 may include information-retrieval module 234 (or a set of instructions) and timing module 242 (or a set of instructions) to determine if one or more stored authentication factors 246 (such as factor A 248-1 or factor B 248-2) have expired. The information-retrieval modules 234 may include a navigation module (or a set of instructions) 236, an identification module (or a set of instructions) 238, and an aggregation module (or a set of instructions) 240.

In some embodiments, memory 224 includes optional stored information 244 (such as retrieved information), optional encryption module (or a set of instructions) 250, and/or one or more optional application modules (or one or more sets of instructions) 252 in addition to the financial module 230.

Instructions in the various modules in the memory 224 may be implemented in a high-level procedural language, an object-oriented programming language, and/or in an assembly or machine language. The programming language may be compiled or interpreted, i.e, configurable or configured to be executed by the one or more processing units 210.

Although the computer system 200 is illustrated as having a number of discrete items, FIG. 2 is intended to be a functional description of the various features that may be present in the computer system 200 rather than as a structural schematic of the embodiments described herein. In practice, and as recognized by those of ordinary skill in the art, the functions of the computer system 200 may be distributed over a large number of servers or computers, with various groups of the servers or computers performing particular subsets of the functions. In some embodiments, some or all of the functionality of the computer system 200 may be implemented in one or more ASICs and/or one or more digital signal processors DSPs.

The computer system 200 may include fewer components or additional components, two or more components may be combined into a single component, and/or a position of one or more components may be changed. In some embodiments the functionality of the computer system 200 may be implemented more in hardware and less in software, or less in hardware and more in software, as is known in the art.

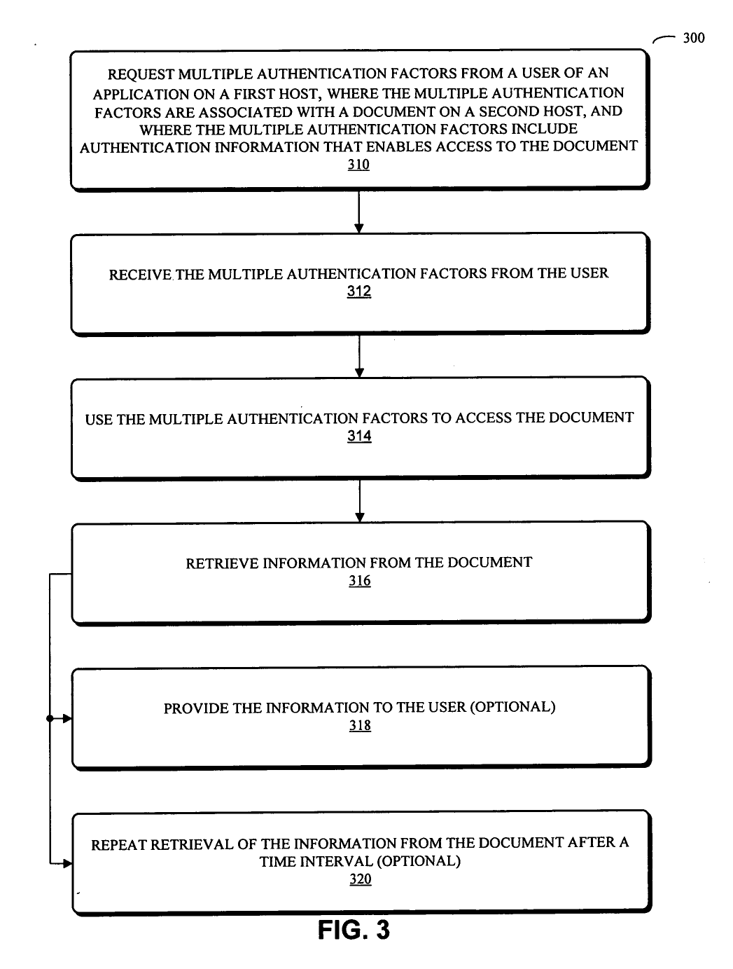

We now discuss methods for retrieving information. FIG. 3 provides a flow chart illustrating a process 300 for retrieving information in accordance with an embodiment of the present invention. During this process, the system requests multiple authentication factors from a user of an application on a first host (310). Note that these authentication factors are associated with a document on a second host, and the authentication factors include authentication information that enables access to the document. Then, the system receives the multiple authentication factors from the user (312). Next, the system uses the authentication factors to access the document (314) and retrieves information from the document (316). In some embodiments, the system optionally provides the information to the user (318) and/or optionally repeats the retrieval of the information from the document after a time interval (320). Note that in some embodiments there may be additional or fewer operations, the order of the operations may be changed, and two or more operations may be combined into a single operation.

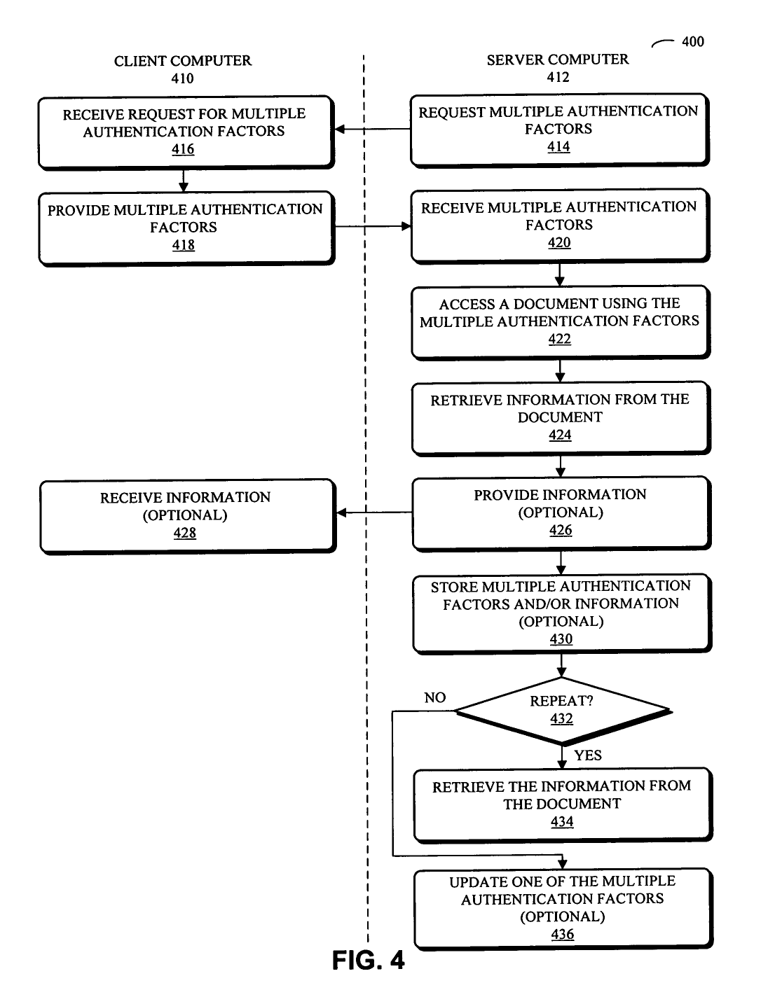

FIG. 4 is a flow chart illustrating a process 400, such as that utilized in an on-line environment, for retrieving information in accordance with an embodiment of the present invention. During process 400, an application executing, at least in part, on a server computer 412 requests multiple authentication factors (414), such as the authentication factors, from a user of the application on client computer 410. The user then receives the request for the multiple authentication factors (416) and provides the multiple authentication factors (418). Next, the system receives the multiple authentication factors (420).

Using the multiple authentication factors, the system accesses (422) and retrieves information from a document (424). In some embodiments, the system optionally provides the information (426) to the user, who optionally receives it (428). In addition, the system may optionally store the multiple authentication factors and/or the information (430). Furthermore, the system may determine whether or not to repeat the retrieval of the information (432), and if yes, the system repeats the retrieval (434).

If one or more of the multiple authentication factors has expired or an authentication requirement of the document has changed, the system may optionally update one of the multiple authentication factors (436), such as a dynamic factor. Such updating may include repeating at least a portion of operations 414, 416, 418, and/or 420. Note that in some embodiments there may be additional or fewer operations, the order of the operations may be changed, and two or more operations may be combined into a single operation.

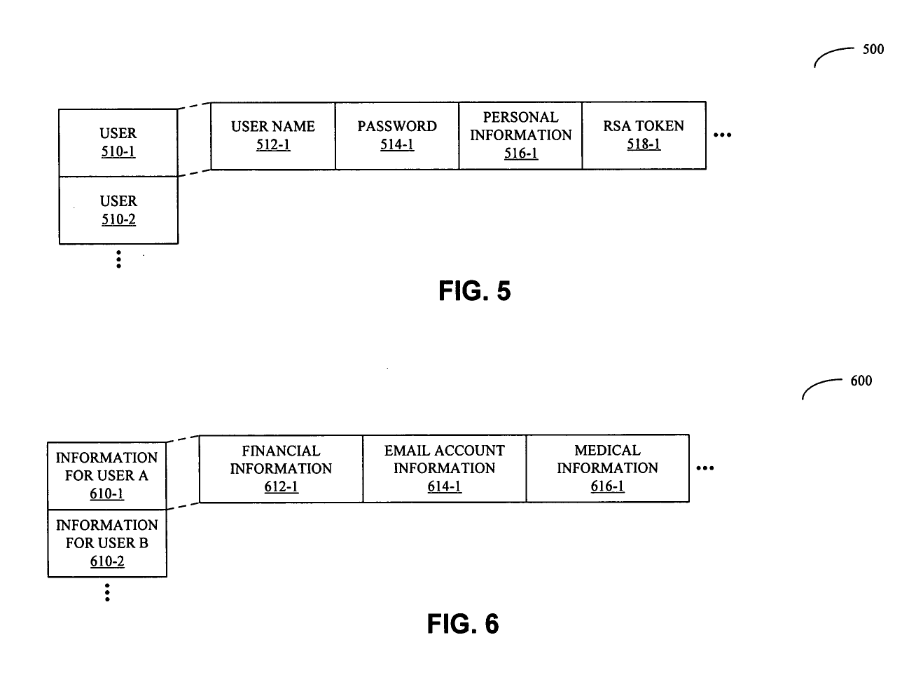

We now discuss data structures that may be used in the computer system 100 (FIG. 1) and/or 200 (FIG. 2). FIG. 5 provides a block diagram illustrating a data structure 500 in accordance with an embodiment of the present invention. This data structure may include authentication information for one or more users 510 of the financial program. For example, for user 510-1, the authentication information may include a user name 512-1, a password 514-1, personal information 516-1, and/or an RSA token 518-1.

FIG. 6 provides a block diagram illustrating a data structure 600 in accordance with an embodiment of the present invention. This data structure may include retrieved information 610 for one or more users of the financial program. For example, for user A 610-1, the retrieved information may include financial information 612-1, email account information 614-1, and/or medical information 616-1. Note that that in some embodiments of the data structures 500 and/or 600 there may be fewer or additional components, two or more components may be combined into a single component, and/or a position of one or more components is changed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for retrieving information, comprising:
requesting multiple authentication factors from a user of an application on a first host, wherein the multiple authentication factors are associated with a document on a second host, and wherein the multiple authentication factors include authentication information that enable access to the document;
receiving the multiple authentication factors from the user;
using the multiple authentication factors to access the document; and
while accessing the document, retrieving the information from the document by:
navigating through the document;
identifying the information; and
aggregating the information.

2. The method of claim 1, further comprising providing the information to the user.

3. The method of claim 1, further comprising storing the information on the first host.

4. The method of claim 1, further comprising storing the multiple authentication factors on the first host.

5. The method of claim 1, further comprising repeating the accessing and retrieving operations after a time interval.

6. The method of claim 5, wherein the accessing and retrieving operations are repeated periodically.

7. The method of claim 5, wherein the accessing and retrieving operations are repeated when the information is changed.

8. The method of claim 1, wherein the first host is a client computer and the second host is a server computer.

9. The method of claim 1, wherein the document includes a website or a web page.

10. The method of claim 1, wherein the application includes a financial application.

11. The method of claim 10, wherein the financial application includes Quicken™.

12. The method of claim 10, wherein the financial application includes TurboTax™.

13. The method of claim 1, wherein the multiple authentication factors include a dynamic factor that is updated after a time interval.

14. The method of claim 13, wherein the dynamic factor includes a Rivest-Shamir-Adleman (RSA) token.

15. The method of claim 1, wherein aggregating the information involves scraping the information from the document.

16. The method of claim 1, wherein the information includes financial information for the user.

17. The method of claim 1, wherein the information includes multiple email accounts for the user.

18. The method of claim 1, wherein the information includes medical information for the user.

19. A computer program product for use in conjunction with a computer system, the computer program product comprising a computer-readable storage medium and a computer-program mechanism embedded therein for configuring the computer system, the computer-program mechanism including:
instructions for requesting multiple authentication factors from a user of an application on a first host, wherein the multiple authentication factors are associated with a document on a second host, and wherein the multiple authentication factors include authentication information that enable access to the document;
instructions for receiving the multiple authentication factors from the user;
instructions for using the multiple authentication factors to access the document; and
instructions for retrieving the information from the document by:
instructions for navigating through the document;
instructions for identifying the information; and
instructions for aggregating the information.

20. A computer system, comprising:
a processor;
memory;
a program module, wherein the program module is stored in the memory and configured to be executed by the processor, the program module including:
instructions for requesting multiple authentication factors from a user of an application on a first host, wherein the multiple authentication factors are associated with a document on a second host, and wherein the multiple authentication factors include authentication information that enable access to the document;
instructions for receiving the multiple authentication factors from the user;
instructions for using the multiple authentication factors to access the document; and
instructions for retrieving the information from the document by:
instructions for navigating through the document;
instructions for identifying the information; and
instructions for aggregating the information.
